(19) United States
(12) Patent Application Publication
(10) Pub. No.: US 2023/0052950 A1
(43) Pub. Date: Feb. 16, 2023

(54) PRE-CODED AUTOMATIC DOCKETING

(71) Applicant: Black Hills IP Holdings, LLC, Minneapolis, MN (US)

(72) Inventor: Steven W. Lundberg, Edina, MN (US)

(21) Appl. No.: 17/722,178

(22) Filed: Apr. 15, 2022

Related U.S. Application Data
(60) Provisional application No. 63/232,813, filed on Aug. 13, 2021.

(51) Int. Cl. G06F 16/93; G06Q 10/06; G06Q 10/10

(52) U.S. Cl. CPC G06F 16/93; G06Q 10/109; G06Q 10/06395; G06Q 50/184

(57) ABSTRACT

Various embodiments disclosed relate to a method of sorting and coding incoming docket tasks and items. The present disclosure includes methods and systems for analyzing and associate pre-codes with incoming electronic communications. In a method of docketing, an electronic communication can be received, a first pre-code can be identified, a second pre-code can be automatically selected and associated with the electronic communication, and the electronic communication can be sent to a docketing system.

### CLAIM OF PRIORITY

This application claims the benefit of priority under 35 U.S.C. § 119(e) to U.S. Provisional Pat. Application Serial No. 63/232,813, filed on Aug. 13, 2021, which is incorporated by reference herein in its entirety.

### BACKGROUND

In a business, docketing systems can be used to track workflow deadlines, tasks, and progress. For example, in a given project, a docketing system can track when the project is opened, what initial filings are due when, and correspondence coming in regarding that project. The docketing system can additionally be used to record deadlines and flag correspondence or documents that may require a response. However, in a general docketing setting, a large number of items and tasks are incoming and often need to be sorted during docketing.

### SUMMARY/OVERVIEW

The present disclosure provides a method of coordinating incoming documents, tasks, and deadlines from electronic communications, for a docketing system. The method can include pre-coding the incoming electronic communications and subsequently sorting the incoming electronic communications based on the pre-coding. This can allow, for example, for more efficient docketing of the incoming electronic communications.

In project management, a large number of incoming communications, documents, and tasks often have to be managed and docketed such that deadlines are recorded and tracked associated with those items. In many types of projects, incoming communications, documents, and tasks, can fall into a pre-determined type. For example, in patent prosecution, an incoming item can include a communication from a foreign agent, a communication from a governmental agency, or other general types of items. When the specific type of project being managed is known, it may be beneficial to pre-sort incoming communications, documents, and tasks, into one or more category, such as large “buckets”, before specifically docketing due dates.

Discussed herein, the use of a pre-coding system can allow for front end sorting of incoming communications, documents, and tasks, for easier, automated docketing down the line. This can help streamline the docketing process, even with a large number of incoming documents.

In an example, a method of docketing an incoming electronic communication can include receiving the incoming electronic communication, wherein the electronic communication comprises unstructured text, identifying a first pre-code for the incoming electronic communication, selecting a second pre-code for associating with the electronic communication based on the type of the electronic communication, wherein the pre-code comprises structured text, automatically associating the second pre-code with the electronic communication, and sending the electronic communication with the pre-code to an automated docketing system.

In an example, a system can include a pre-code library comprising a plurality of pre-codes for associations with docketing tasks, a pre-coding application configured to receive incoming docketing tasks and correlate each docketing task to at least one of the plurality of pre-codes, and a user interface for presentation of the docketing task and correlated pre-code, such that a user can review the correlation by the pre-coding application.

In an example, a machine readable medium can include a processor and a memory with instructions, which when executed, cause the processor to: receive an incoming electronic communication, wherein the electronic communication comprises unstructured text; identify a pre-code for associating with the electronic communication based on the unstructured text of the electronic communication, wherein the pre-code comprises structured text; associate the pre-code with the electronic communication; send the electronic communication with the pre-code to an automated docketing system.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an automated docketing system in a sample embodiment.

FIG. 2 illustrates sample third party data sources that provide docketing data input for an automated docketing system implemented for managing patent portfolios in a sample embodiment.

FIG. 3 is a schematic diagram of a docketing system including a pre-coding application in an example.

FIG. 4 is a flow chart depicting a user interface for a pre-coding application in an example.

FIG. 5 is an example incoming electronic communication with an associated pre-code in an example.

FIG. 6 is a flow chart depicting a method of docketing an incoming electronic communication using a pre-coding method in an example.

FIG. 7 illustrates a block diagram of an example computing machine upon which any one or more of the techniques or methodologies discussed herein may be implemented.

### DETAILED DESCRIPTION

The present disclosure describes, among other things, is a method of pre-coding incoming electronic communications for automated docketing of those communications. The incoming electronic communication can be categorized in one of several pre-determined categories and appropriate coded such that the electronic communication includes associated structured text when the electronic communication is forward to an automated or semi-automated docketing system. The docketing system can interpret the associated structured text to aid in automatically docketing the electronic communication.

As used herein, “electronic communication” refers to an electronic message or a method of exchanging messages between people using electronic devices.

As used herein, “template” can include a preset format for a document or file, used so that the format does not have to be recreated each time it is used. In some cases, a template can include one or more fields to be filled out.

As used herein, “application” or “program” can include a program or piece of software designed and written to fulfill a particular purpose of the user, such as a database application.

As used herein, “associate” can include a partner or colleague in business or at work, either internal or external.

As used herein, “unstructured text” or “unstructured data” refers to data that is not organized in a standard format, for example, text in the body of an electronic communication.

As used herein, “structured text” or “structured data” refers to data that is organized in a standard format such that a recipient may read the data and institute an automated computing system action without human interpretation of the data.

As used herein, “scraping,” “web scraping,” “data scraping,” or “web crawling,” can refer to automatically mining or collecting data or information, such as from a database or from the internet.

As used herein, “file” or “matter” can refer to a particular project, enterprise, or undertaking being worked on by an individual or a collaborative group, planned and designed to achieve a particular aim.

As used herein, “official record,” or “file history,” can refer to data about a file or matter denoting evidence about past events or tasks within that file or matter, such as an electronic record of previous events in the file or matter. An “official record” can be stored with and maintained by an overseeing agency or organization, such as a governmental organization.

As used herein, “database,” can refer to a structured set of data, such as held in a computer or on the internet, that can be accessible in various ways.

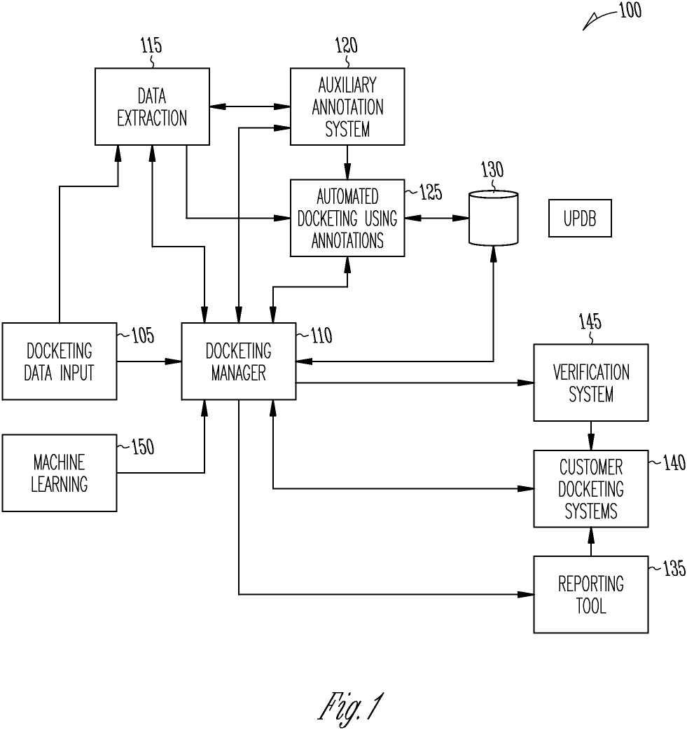

FIG. 1 is a block diagram of a docketing system 100 in an example. The docketing system 100 can be automated or semi-automated. The docketing system 100 can include docketing data input 105, docketing manger 110, data extraction 115, auxiliary annotation system 120, automated docketing using annotations 125, Universal Procedures Database 130, reporting tool 135, customer docketing system 140, verification system 145, and machine learning 150.

The automated docketing system 100 can receive documents from third party sources including third party docketing systems and/or customer data as docketing data input 105. The docketing manger system 110 can process the received documents to provide to the customer docketing systems 140 and prepare the documents for data extraction by the data extraction system 115 as needed.

The data extraction system 115 can perform Optical Character Recognition (OCR) on the received documents from the docketing manger system 110 to extract data, read checkboxes, extract lists, and identify documents where possible. The docketing manger system 110 can also integrate with a Universal Procedures Database (UPDB) 130 to provide automated docketing by an automated docketing tool 125 that processes received documents based on the additional annotations added to the documents based on the complex data extraction performed by the Auxiliary Annotation System (AAS) 120.

The AAS 120 may further identify the received documents without using an OCR. To manage this process, the docketing manger system 110 can receive frequent updates of docketing procedure rules including configuration data and updates the UPDB 130 with universal procedure codes (UPCs) as appropriate. The UPCs can be used in conjunction with customer specific codes, checklists, and templates. The rules can specify how to fill in the templates and how to complete customer-specific procedures such as how to docket documents into the customer’s docketing system 140, for example. The template can be filled out by pulling in attributes from the annotations in a document.

The docketing manger system 110 can receive or intake documents and docketing data from several different sources of docketing data input 105, validate the docketing items against entries in a customer’s docketing system 140, and communicate those documents to the customer’s docketing system 140 via a unified interface. The docketing manger system 110 can also route documents and associated docketing data through the data extraction system 115 and the AAS 120 and organizes the returned metadata and annotations. The docketing manger system 110 thus can provide a breakout between the metadata and the document text.

The docketing manger system 110 can also keep records and communicate with third-party application programming interfaces (APIs) to push the docketing data and documents automatically where allowed. Otherwise, the docketing manger system 110 can present the documents to human docketers to docket. The docketing manger system 110 may also issue reports upon request.

The Docketing manger system 110 can be integrated with a customer’s existing docketing system (e.g., Foundation IP), semi-integrated (e.g., CPI, Anaqua, etc.), may provide a virtual host that does not talk at all to the customer’s existing docketing system (e.g., Lecopio, IP Manager, Memotech), or may provide outputs in spreadsheet form for use by a docketing administrator to update the customer’s docking system 140.

If the Docketing manger system 110 and the customer’s docketing system are not integrated, the data output of automated docketing system 100 may be presented to a human docketer for manual entry. For example, the human docketer may implement macros that interface with the customer’s docketing system 140 to populate the received data into the customer’s docketing system 140.

On the other hand, if the docketing manger system 110 and the customer’s docketing system 140 are integrated or semi-integrated, the data output may be processed to determine if any data is missing to automate the docketing process. If anything is missing, the human docketer can add that information before the automated docketing process may proceed further or the data may be auto-populated and mapped to the template from the UPDB 130.

The automated docketing system 100 can also perform several post-docketing actions, such as sending docketing reports/details to an external verification system 145 that use a set of rules to verify proper docketing in a host system. The verification system 145 can verifie that the data is correctly added to the external customer’s docketing system 140. For example, the verification system 145 can pull data from the AAS 120, the docketing manger system 110, and the customer’s docketing system 140 to compare what is present to what is expected to be present in the respective systems.

The automated docketing system 100 may also provide automated email “report out” notifications to customers by implementing a reporting tool 135 that specifies docketing actions based on UPDB template configurations. The reporting tool 135 can also provide completed docketing reports to customers either directly or via the customers’ docketing system 140.

In some cases, machine learning techniques may be used to generate annotations. For example, a database of past documents that have been identified may be provided by the docketing manger system 110 and used as a data warehouse to train and improve machine learning models by creating a training set for the machine learning model. Over time, the machine learning model system 150 can learn which PTO IDs to use for which documents, which document in a bundle of documents may be used to characterize the bundle, and may provide predicted PTO IDs for the received documents. The machine learning model system 150 can also establish rule engine prediction capabilities for received documents that test the classifications.

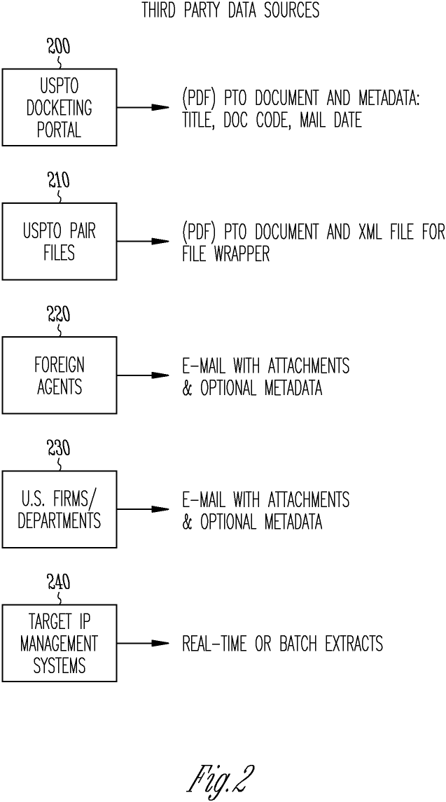

FIG. 2 illustrates sample third party data sources that provide docketing data input 105 for an automated docketing system 100 implemented for managing patent portfolios in an example. As illustrated in FIG. 2, the third party data sources may include the Patent Office (e.g., USPTO) docketing portal 200, which provides documents from the USPTO in portable document format (PDF) and includes metadata identifying the title, document code, and mail date for the corresponding document. The third party data sources may further include USPTO PAIR extensible markup language (XML) files 210, which provide documents from the USPTO in PDF and includes an XML file for patent file wrappers. The third party data sources may also include foreign agents 220 who provide emails with attachments and optional metadata. Foreign agents 220 may also provide hard copy documents that may be scanned for data entry. Similarly, law firms and/or corporate law departments 230 may provide emails with attachments and optional metadata as well as hard copy documents that may be scanned for data entry. Also, third party docketing systems 240 may provide real-time or batch extracts of data for entry into a docketing management system.

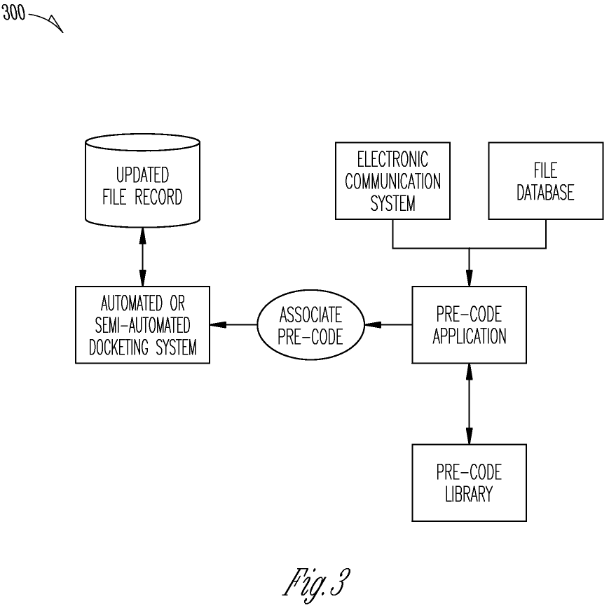

FIG. 3 is a schematic diagram of a docketing system 300 including a pre-coding application 320 in an example. The system 300 can include electronic communication system 310, file database 312, pre-coding application 320 with library 322, docketing system 330, and filed records 332.

The electronic communication system 310 can be, for example, an e-mail server or other communication system. The file database 312 can include a repository of files or projects being working on by the company.

The pre-coding application 320 can be a program or app, located on the internet or locally on a device, for processing of incoming notices of events or documents occurring within an ongoing project. The pre-coding application 320 can work in conjunction with the other components of system 300 to maintain and update records, tasks, and deadlines, for projects being worked on internally or in cooperation with one or more outside organizations.

The library 322 can serve as a repository of pre-codes. The library 322 can host the pre-codes with which the pre-coding application 320 can interact. The pre-code library 322 can be organized, for example, by pre-code type, such as pre-codes related to a particular outside associate, or related to a particular type of item in a file. The pre-code application 320 can have access to the pre-code library 322 and selectively pull pre-codes from the library 322 for use when a particular item to be docketed comes in.

The pre-coding application can, in some cases, be trained through machine learning to recognize and select the appropriate pre-code, use a look-up table or database, or other appropriate methods at this step. In some cases, the pre-code application can be trained to identify the source of the item to be docketed, such as by an address or electronic name (e.g., an e-mail address or website) from which the item is provided. In some cases, the pre-code application can use a text recognition technique to analyze the incoming communication to identify key words, phrases, numbering, or concepts, and correlate these to a specific type of item to be docketed. The pre-code can then be associated with the item at 324.

The docketing system 330 can be an automated or semi-automated docketing system, such as the docketing system discussed above with reference to FIG. 1. The docketing system 330 can be in communication with the pre-coding application 320, and can receive documents, tasks, and communications with associated pre-code from the pre-coding application 320. The docketing system 330 can communicate with and update the file records 332.

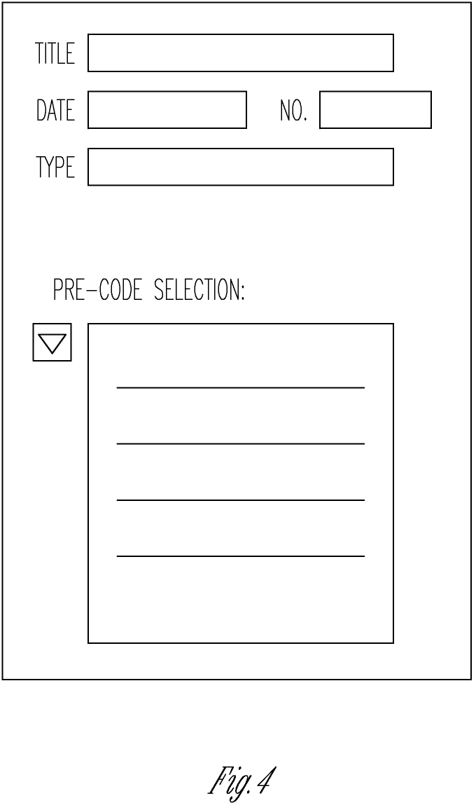

FIG. 4 is a diagram depicting a user interface 400 for a pre-coding application in an example. The user interface 400 can be, for example, on a computer monitor or other electronic device, such as a tablet or phone. The user interface 400 can include bibliographic information fields, such as a file title, event date, file number, and file type. Additionally, the user interface 400 can include a field for the associated pre-codes. The field can include, for example, a list, menu, pop-up, drop-down menu, or other method of selecting one or more pre-codes for association with the task, communication, or document. Such a user interface can be used, for example, to assign one or more pre-codes to an incoming communication.

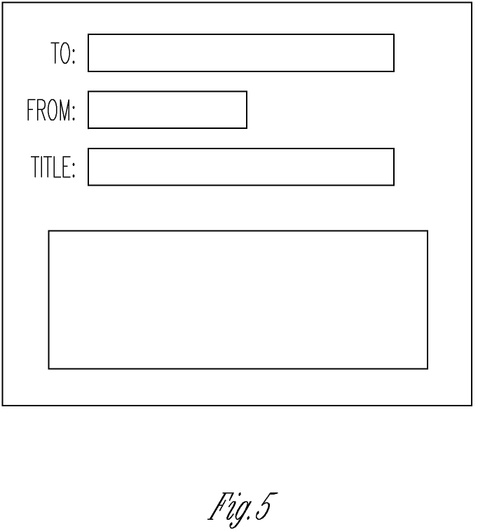

FIG. 5 is an example incoming electronic communication 500 with an associated pre-code. The electronic communication 500 can, for example, be an incoming email, text message, instant message, or other form of incoming electronic communication. The electronic communication 500 can include details on an upcoming task or deadline, and may include one or more documents.

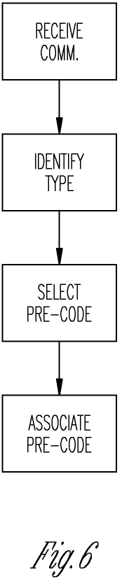

FIG. 6 is a flow chart depicting a method 600 of docketing an incoming electronic communication using a pre-coding method in an example. The method 600 can include operations 610 to 618.

At operation 610, the pre-coding application can receive an incoming electronic communication. The electronic communication, such as an e-mail, can include unstructured text, such as a free form message or other text in the body of the electronic communication.

At operation 612, the pre-coding application can identify a first pre-code for the incoming electronic communication. In some cases, the pre-coding application can automatically select the first pre-code. In some cases, the first pre-code can be manually selected. The first pre-code can be, for example, a broader or more general category. For example, when an e-mail comes in from a governmental agency reporting an office communication, the pre-coding application can identify a pre-code indicating an official communication.

At operation 614, the pre-coding application can select a second pre-code to associate with the electronic communication. The secondary pre-code can be more specific than the first pre-code. For example, if the first pre-code denote an official communication, the second pre-code can denote which office the communication is from, such as a domestic or foreign office. Selecting a second pre-code can be further based on the unstructured text of the electronic communication. At operation 616, the second pre-code can be automatically associated with the electronic communication.

The pre-codes can, for example, denote a communication from an international associate or a communication from a governmental agency. In some cases, the pre-codes can denotes a reminder or an upcoming deadline. In some cases, the pre-codes can comprise a structured text to associate with the electronic communication. In some cases, multiple pre-codes can be applied.

At operation 618, the electronic communication with the pre-code can be sent to an automated docketing system. In some cases, the electronic communication can be sent with the associated pre-code to a queue for review prior to sending to the automated docketing system. In some cases, the electronic communication with the associated pre-code can be reviewed for accuracy prior to sending to the automated docketing system. In some cases, the pre-code application can determine whether a pre-code is applicable after identifying a type of the incoming electronic communication. In some cases, if a pre-code is not applicable, the electronic communication can be sent for review.

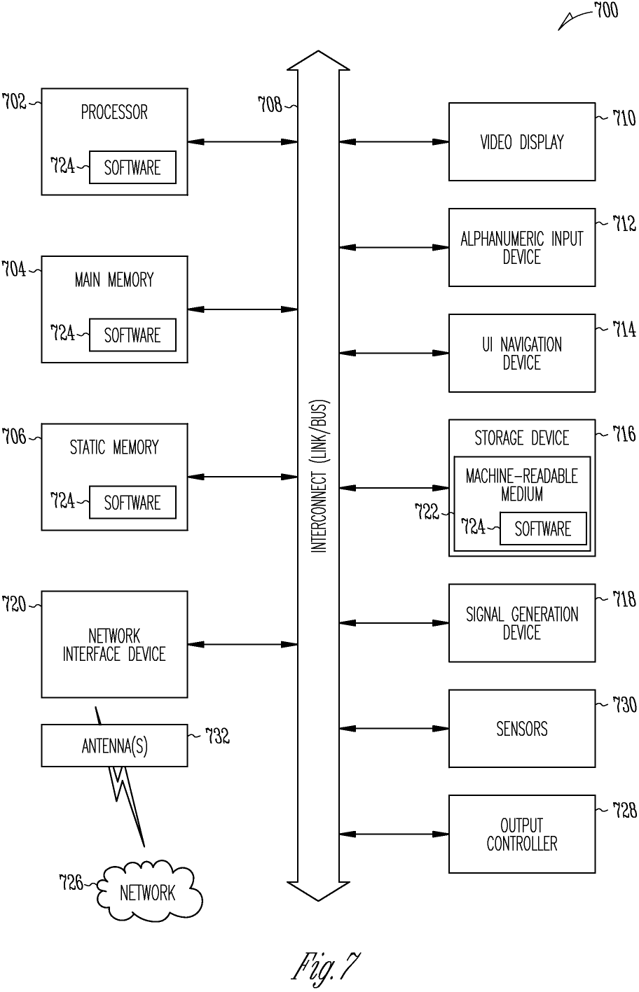

FIG. 7 illustrates a block diagram of an example computing system machine 700 upon which any one or more of the techniques (e.g., methodologies) discussed herein may perform. Machine 700 (e.g., computer system) may include a hardware processor 702 (e.g., a central processing unit (CPU), a graphics processing unit (GPU), a hardware processor core, or any combination thereof), a main memory 704 and a static memory 706, connected via an interconnect 708 (e.g., link or bus), as some or all of these components may constitute hardware for systems 100 or 200 or hardware to operate the services and subsystems and related implementations discussed above.

Specific examples of main memory 704 include Random Access Memory (RAM), and semiconductor memory devices, which may include, in some embodiments, storage locations in semiconductors such as registers. Specific examples of static memory 706 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 700 may further include a display device 710, an input device 712 (e.g., a keyboard), and a user interface (UI) navigation device 714 (e.g., a mouse). In an example, the display device 710, input device 712 and UI navigation device 714 may be a touch screen display. The machine 700 may additionally include a mass storage device 716 (e.g., drive unit), a signal generation device 718 (e.g., a speaker), a network interface device 720, and one or more sensors 730, such as a global positioning system (GPS) sensor, compass, accelerometer, or some other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the hardware processor 702 and/or instructions 724 may comprise processing circuitry and/or transceiver circuitry.

The mass storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the mass storage device 716 constitutes, in at least some embodiments, machine readable media.

The term “machine readable medium” includes, in some embodiments, any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Specific examples of machine readable media include, one or more of non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks. While the machine readable medium 722 is illustrated as a single medium, the term “machine readable medium” includes, in at least some embodiments, a single medium or multiple media (e.g., a centralized or distributed database, and/or associated caches and servers) configured to store the one or more instructions 724. In some examples, machine readable media includes non-transitory machine readable media. In some examples, machine readable media includes machine readable media that is not a transitory propagating signal.

The instructions 724 are further transmitted or received, in at least some embodiments, over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

An apparatus of the machine 700 includes, in at least some embodiments, one or more of a hardware processor 702 (e.g., a central processing unit (CPU), a graphics processing unit (GPU), a hardware processor core, or any combination thereof), a main memory 704 and a static memory 706, sensors 730, network interface device 720, antennas 732, a display device 710, an input device 712, a UI navigation device 714, a mass storage device 716, instructions 724, a signal generation device 718, and an output controller 728. The apparatus is configured, in at least some embodiments, to perform one or more of the methods and/or operations disclosed herein. The apparatus is, in some examples, a component of the machine 700 to perform one or more of the methods and/or operations disclosed herein, and/or to perform a portion of one or more of the methods and/or operations disclosed herein.

In an example embodiment, the network interface device 720 includes one or more physical jacks (e.g., Ethernet, coaxial, or phone jacks) or one or more antennas to connect to the communications network 726. In an example embodiment, the network interface device 720 includes one or more antennas 732 to wirelessly communicate using at least one of single-input multiple-output (SIMO), multiple-input multiple-output (MIMO), or multiple-input single-output (MISO) techniques. In some examples, the network interface device 720 wirelessly communicates using Multiple User MIMO techniques. The term “transmission medium” shall be taken to include any intangible medium that is capable of storing, encoding or carrying instructions for execution by the machine 700, and includes digital or analog communications signals or other intangible medium to facilitate communication of such software.

At least some example embodiments, as described herein, include, or operate on, logic or a number of components, modules, or mechanisms. Such components are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a component that operates to perform specified operations. In an example, the software resides on a machine readable medium. In an example, the software, when executed by the underlying hardware of the component, causes the hardware to perform the specified operations.

Accordingly, such components are understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the modules need not be instantiated at any one moment in time. For example, where the components comprise a general-purpose hardware processor configured using software, in some embodiments, the general-purpose hardware processor is configured as respective different components at different times. Software accordingly configures a hardware processor, for example, to constitute a particular component at one instance of time and to constitute a different component at a different instance of time.

Some embodiments are implemented fully or partially in software and/or firmware. This software and/or firmware takes the form of instructions contained in or on a non-transitory computer-readable storage medium, in at least some embodiments. Those instructions are then read and executed by one or more hardware processors to enable performance of the operations described herein, in at least some embodiments. The instructions are in any suitable form, such as but not limited to source code, compiled code, interpreted code, executable code, static code, dynamic code, and the like. Such a computer-readable medium includes any tangible non-transitory medium for storing information in a form readable by one or more computers, such as but not limited to read only memory (ROM); random access memory (RAM); magnetic disk storage media; optical storage media; flash memory, etc.

Various embodiments may be implemented fully or partially in software and/or firmware. This software and/or firmware may take the form of instructions contained in or on a non-transitory computer-readable storage medium. Those instructions are then read and executed by one or more processors to enable performance of the operations described herein. The instructions are in any suitable form, such as but not limited to source code, compiled code, interpreted code, executable code, static code, dynamic code, and the like. Such a computer-readable medium includes, in at least some embodiments, any tangible non-transitory medium for storing information in a form readable by one or more computers, such as but not limited to read only memory (ROM); random access memory (RAM); magnetic disk storage media; optical storage media; flash memory, etc.

### Various Notes & Examples

Example 1 can include a method of docketing an incoming electronic communication, the method comprising: receiving the incoming electronic communication, wherein the electronic communication comprises unstructured text; identifying a first pre-code for the incoming electronic communication; selecting a second pre-code for associating with the electronic communication based on the type of the electronic communication, wherein the pre-code comprises structured text; automatically associating the second pre-code with the electronic communication; sending the electronic communication with the pre-code to an automated docketing system.

Example 2 can include Example 1, wherein the secondary pre-code is more specific than the first pre-code.

Example 3 can include any of Examples 1-3, wherein at least one of the first and second pre-codes denotes a communication from an international associate or a communication from a governmental agency.

Example 4 can include any of Examples 1-4, wherein at least one of the first and second pre-codes denotes a reminder or an upcoming deadline.

Example 5 can include any of Examples 1-5, wherein associating the second pre-code comprises adding structured text to the electronic communication, the structured text denoting the pre-code.

Example 6 can include any of Examples 1-6, wherein selecting a second pre-code is further based on the unstructured text of the electronic communication.

Example 7 can include any of Examples 1-1, further comprising sending the electronic communication with the associated pre-code to a queue for review prior to sending to the automated docketing system.

Example 8 can include any of Examples 1-7, further comprising reviewing the electronic communication with the associated pre-code for accuracy prior to sending to the automated docketing system.

Example 9 can include any of Examples 1-8, further comprising determining whether a pre-code is applicable after identifying a type of the incoming electronic communication.

Example 10 can include any of Examples 1-9, wherein, if a pre-code is not applicable, sending the electronic communication for review.

Example 11 can include any of Examples 1-10, further comprising applying more than one pre-code to the electronic communication.

Example 12 can include a system comprising: a pre-code library comprising a plurality of pre-codes for associations with docketing tasks; a pre-coding application configured to receive incoming docketing tasks and correlate each docketing task to at least one of the plurality of pre-codes; and a user interface for presentation of the docketing task and correlated pre-code, such that a user can review the correlation by the pre-coding application.

Example 13 can include Example 12, further comprising an electronic communication server configured to receive incoming docketing tasks and communicate the incoming docket tasks to the pre-coding application.

Example 14 can include any of examples 12-13, further comprising a docketing system configured to receive the docketing task and correlated pre-codes from the pre-coding application.

Example 15 can include any of examples 12-14, wherein the docketing system is at least partially automated.

Example 16 can include any of examples 12-15, wherein the docketing system is configured to interpret the pre-code correlated with the docket tasks, and execute one or more actions based on the pre-code.

Example 17 can include any of examples 12-16, wherein a portion of the plurality of pre-codes indicate a communication from an international associate or a communication from a governmental agency.

Example 18 can include any of examples 12-17, wherein a portion of the plurality of pre-codes indicate a reminder or an upcoming deadline.

Example 19 can include any of examples 12-18, wherein the plurality of pre-codes comprise categories and sub-categories.

Example 20 can include a machine readable medium, comprising a processor and a memory with instructions, which when executed, cause the processor to: receive an incoming electronic communication, wherein the electronic communication comprises unstructured text; identify a pre-code for associating with the electronic communication based on the unstructured text of the electronic communication, wherein the pre-code comprises structured text; associate the pre-code with the electronic communication; send the electronic communication with the pre-code to an automated docketing system.

Example 21 can include machine readable medium of Example 20, further comprising instructions identify a type for the electronic communication and identify the pre-code based on the type.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms "a" or "an" are used, as is common in patent documents, to include one or more than one, independent of any other instances or usages of "at least one" or "one or more." In this document, the term "or" is used to refer to a nonexclusive or, such that "A or B" includes "A but not B," "B but not A," and "A and B," unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of docketing an incoming electronic communication, the method comprising:
receiving the incoming electronic communication, wherein the electronic communication comprises unstructured text;
identifying a first pre-code for the incoming electronic communication;
selecting a second pre-code for associating with the electronic communication based on the type of the electronic communication, wherein the pre-code comprises structured text;
automatically associating the second pre-code with the electronic communication;
sending the electronic communication with the pre-code to an automated docketing system.

2. The method of claim 1, wherein the secondary pre-code is more specific than the first pre-code.

3. The method of claim 1, wherein at least one of the first and second pre-codes denotes a communication from an international associate or a communication from a governmental agency.

4. The method of claim 1, wherein at least one of the first and second pre-codes denotes a reminder or an upcoming deadline.

5. The method of claim 1, wherein associating the second pre-code comprises adding structured text to the electronic communication, the structured text denoting the pre-code.

6. The method of claim 1, wherein selecting a second pre-code is further based on the unstructured text of the electronic communication.

7. The method of claim 1, further comprising sending the electronic communication with the associated pre-code to a queue for review prior to sending to the automated docketing system.

8. The method of claim 7, further comprising reviewing the electronic communication with the associated pre-code for accuracy prior to sending to the automated docketing system.

9. The method of claim 1, further comprising determining whether a pre-code is applicable after identifying a type of the incoming electronic communication.

10. The method of claim 9, wherein, if a pre-code is not applicable, sending the electronic communication for review.

11. The method of claim 1, further comprising applying more than one pre-code to the electronic communication.

12. A system comprising:
a pre-code library comprising a plurality of pre-codes for associations with docketing tasks;
a pre-coding application configured to receive incoming docketing tasks and correlate each docketing task to at least one of the plurality of pre-codes; and
a user interface for presentation of the docketing task and correlated pre-code, such that a user can review the correlation by the pre-coding application.

13. The system of claim 12, further comprising an electronic communication server configured to receive incoming docketing tasks and communicate the incoming docket tasks to the pre-coding application.

14. The system of claim 13, further comprising a docketing system configured to receive the docketing task and correlated pre-codes from the pre-coding application.

15. The system of claim 14, wherein the docketing system is at least partially automated.

16. The system of claim 15, wherein the docketing system is configured to interpret the pre-code correlated with the docket tasks, and execute one or more actions based on the pre-code.

17. The system of claim 12, wherein a portion of the plurality of pre-codes indicate a communication from an international associate or a communication from a governmental agency.

18. The system of claim 12, wherein a portion of the plurality of pre-codes indicate a reminder or an upcoming deadline.

19. The system of claim 12, wherein the plurality of pre-codes comprise categories and subcategories.

20. A machine readable medium, comprising a processor and a memory with instructions, which when executed, cause the processor to:
receive an incoming electronic communication, wherein the electronic communication comprises unstructured text;
identify a pre-code for associating with the electronic communication based on the unstructured text of the electronic communication, wherein the pre-code comprises structured text;
associate the pre-code with the electronic communication;
send the electronic communication with the pre-code to an automated docketing system.
